(19) United States
(12) Patent Application Publication
(10) Pub. No.: US 2014/0076804 A1
(43) Pub. Date: Mar. 20, 2014

(54) Struvite Precipitation Using Magnesium Sacrificial Anode

(71) Applicants: Damian J. Kruk, Winnipeg (CA); Jan A. Oleszkiewicz, Winnipeg (CA)

(72) Inventors: Damian J. Kruk, Winnipeg (CA); Jan A. Oleszkiewicz, Winnipeg (CA)

(21) Appl. No.: 14/031,280

(22) Filed: Sep. 19, 2013

Related U.S. Application Data
(60) Provisional application No. 61/702,989, filed on Sep. 19, 2012.

(51) Int. Cl. C02F 1/463

(52) U.S. Cl. CPC C02F 1/463
USPC 210/631; 205/742; 205/743

(57) ABSTRACT

A method precipitating struvite in wastewater uses a magnesium sacrificial anode as the only source of magnesium. A high-purity magnesium alloy cast anode was found to be very effective in recovery of high-quality struvite from water solutions and from supernatant of fermented waste activated sludge (WAS) from a high-purity oxygen wastewater treatment plant. Struvite purity was strongly dependent on the pH and the electric current density. Optimum pH of the solution was in the broad range between 7.5 and 9.3, with struvite purities exceeding 90%. The precipitated struvite accumulated in bulk liquid with significant portions attached to the anode surface from which regular detachment occurred.

This application claims the benefit under 35 U.S.C.119(e) of U.S. provisional application Ser. No. 61/702,989, filed Sep. 19, 2012.

### FIELD OF THE INVENTION

The present invention relates to the treatment of wastewater including precipitation of struvite, and more particularly the present invention relates to precipitation of struvite in wastewater by electro-coagulation with a magnesium sacrificial anode.

### BACKGROUND

Uncontrolled struvite (NH₄MgPO₄·6H₂O) deposition in pipes, on reactor walls and on submerged surfaces of devices (Ben Moussa et at 2006; Le Corre et at 2005; Suzuki et at 2007), significantly increases maintenance costs (Doyle et al 2002). Numerous researchers have shown feasibility of struvite production from anaerobically digested sludge dewatering liquors and from livestock manure (Schuiling and Andrade 1999; Suzuki et al 2005; Suzuki et al 2007; Zeng and Li 2006, Doyle et al 2002) since they are rich in phosphates and ammonia. Struvite precipitates in form of stable white orthorhombic crystals (Le Corre et al 2005)—the precipitation reaction can be expressed as (Zeng and Li 2006):

Mg²⁺+NH₄⁺+HPO₄²⁻+6H₂O→MgNH₄PO₄↓6H₂O+H⁺ [1]

Published research (Ben Moussa at al 2006; Doyle et al 2002; Le Corre et al 2005; Stratful et al 2001; Zeng and Li 2006) indicated that the most important factors affecting struvite precipitation were the molar ratio Mg²⁺:NH₄⁺:PO₄³⁻, pH, substrates saturation as well as the presence of other ions (e.g. Ca²⁺, K⁺, CO₃²⁻). According to Hao et al. (2008) optimal molar ratio of Mg:N:P was 1.2:3:1. The pH affects saturation index by changing the specification of struvite substrates and other competing precipitates, such as magnesium phosphate or magnesium carbonate. It is generally agreed that struvite precipitation occurs when pH is higher than 7.5 and it rapidly increases until pH 10.5 (Doyle et al. 2002; Zeng and Li 2006). Hao et al. (2008) showed that optimal pH for precipitation of high purity struvite (>90%) was between 7.5 and 9 and dropped to 7.0 to 7.5 when Ca²⁺ ions were present. Above pH of 9, or above pH of 7.5 in the presence of calcium, the precipitation of phosphates took place in form of magnesium or calcium phosphates (Hao et al 2008).

The most popular method of struvite deposition from wastewater is chemical precipitation by dosing magnesium salts and adjusting pH with a base

(Schuiling and Andrade 1999; Suzuki et al 2007; Zeng and Li 2006) or by stripping CO₂ using aeration (Suzuki et al 2005; Suzuki et al 2007). Among magnesium sources most frequently used are MgCl₂, MgO and MgSO₄ (Hug and Udert 2013). Other magnesium compounds like Mg(OH)₂ and MgCO₃ are much less suitable due to their low solubility in water (Schuiling and Andrade 1999; Zeng and Li 2006).

Ben Moussa (2006) and Wang (2010) proposed to eliminate the need for alkalinity dosing using electrolytic cell with inert anodes. In accordance with the overall reaction of oxygen reduction and hydrogen evolution, equations [2] and [3], hydroxide anions are produced on the cathode surface. The process was shown to increase the interfacial pH of cathode by as high as 1.5 units in comparison to the bulk solution (Ben Moussa et al 2006). Thus, struvite deposition can be done in neutral pH of bulk solution (Ben Moussa et al 2006; Wang et al 2010). Ben Moussa et al. 2006 reported that electrochemical methods allowed production of pure struvite. In both cases external magnesium source was dosed.

O₂+2H₂O+4e⁻→4HO⁻ [2]

2H₂O+2e⁻→H₂↑+2HO⁻

### SUMMARY OF THE INVENTION

Struvite precipitation using magnesium sacrificial anode as the only source of magnesium is presented. High-purity magnesium alloy cast anode was found to be very effective in recovery of high-quality struvite from water solutions and from supernatant of fermented waste activated sludge (WAS) from a high-purity oxygen wastewater treatment plant. Struvite purity was strongly dependent on the pH and the electric current density. Optimum pH of the solution was in the broad range between 7.5 and 9.3, with struvite purities exceeding 90%. Increasing current density resulted in elevated struvite purities. No upper limits were observed in the studied current range of 50 mA to 200 mA. Phosphorus removal rate was proportional to the current density and comparable for tests with water solutions and the supernatant from fermented sludge. The highest P-removal rate achieved was 4.0 mg PO₄—P cm⁻² h⁻¹ at electric current density of 45 A m⁻². Initial substrate concentrations affected the rate of phosphorus removal. The precipitated struvite accumulated in bulk liquid with significant portions attached to the anode surface from which regular detachment occurred.

The objective of this study was to assess the suitability of struvite precipitation from the supernatant of fermented waste activated sludge (WAS). The waste activated sludge in the experimental embodiments described herein were obtained from a high purity oxygen reactor at the South End Water Pollution Control Centre in Winnipeg, Manitoba, Canada, using a sacrificial magnesium anode as the sole source of magnesium. Specific objectives were to determine the impact of solution pH and electric current on purity of the produced struvite and the phosphorus removal ratio.

According to one aspect of the invention there is provided a method of precipitating struvite in wastewater, the method comprising:

providing a plurality of electrodes in contact with the wastewater in which at least one electrode comprises a sacrificial anode comprising magnesium; and

applying a current across the electrodes so as to precipitate the struvite by electro-coagulation.

Preferably the sacrificial anode consists substantially entirely of magnesium, for example the sacrificial anode may have a magnesium purity of approximately 99%.

Preferably the sacrificial anode is the only magnesium added to the wastewater.

The wastewater being treated can include treated wastewater, raw wastewater, livestock manure, or digested municipal sludge concentrates for example.

When biologically treating the wastewater, the method preferably also includes maintaining a current density of the current applied to the sacrificial anode below a prescribed threshold which is detrimental to the biological treatment.

When the objective is to remove phosphorous from the wastewater the method may include increasing a magnitude of the current being applied in response to a measured concentration of phosphorous in an effluent from the treatment chamber exceeding a prescribed phosphorous limit.

One embodiment of the invention will now be described in conjunction with the accompanying drawings in which:

### BRIEF DESCRIPTION OF THE DRAWINGS

FIG. 1 illustrates XRD spectra for precipitate produced in tests T2-T7 and spectrum for pure struvite (NH4MgPO4.6H2O) according to International Centre for Diffraction Data.

FIG. 2 illustrates struvite purity and PO4-P removal rate as a function of bulk solution pH at I=50 mA.

FIG. 3 illustrates struvite purity and PO4-P removal rate as a function of electric current at pH of 7.5.

FIG. 4 illustrates combined profiles of ammonia and phosphate concentrations for tests T8-T12.

FIG. 5 illustrates ammonia and phosphate concentrations profiles for test T13.

FIG. 6 illustrates soluble P and pH profiles in struvite precipitation tests with fermented sludge supernatant; pH was not controlled; electric current was set to 50, 100 and 200 mA in consecutive tests; two test conducted on sludge fermented for 2d and one test on sludge fermented for 3d.

FIG. 7 illustrates soluble P and ammonia N removed in struvite precipitation test wherein WAS was after 3d fermentation, pH was not controlled, and electric current was 50 mA.

FIG. 8 is a schematic representation of an exemplary wastewater treatment system for precipitating struvite.

In the drawings like characters of reference indicate corresponding parts in the different figures.

### DETAILED DESCRIPTION

Turning initially to FIG. 8, a wastewater treatment system 10 according to the present invention is schematically represented. The system 10 includes a suitable vessel 12 for containing a batch of wastewater to be treated therein. The vessel 12 includes a wastewater inlet 14 for introducing wastewater into the vessel therethrough and a wastewater outlet 16 from which the treated wastewater is arranged to be discharged.

A plurality of electrodes 18 are supported in the vessel for contact with the wastewater to be treated in the vessel. The electrodes 18 are connected to a suitable power supply 20 which is arranged to apply a current between the electrodes across the wastewater being treated. At least one of the electrodes 18 is a sacrificial magnesium electrode as described in the following.

Additionally the system 10 can be provided with a pH probe 22 for monitoring pH in the wastewater being treated. Additional sensors 24 may be provided in communication with the wastewater being treated or the already treated wastewater in the effluent in the wastewater outlet for monitoring the effectiveness of the treatment.

Material and methods

Both the synthetic pure water solution and the WAS supernatant tests were conducted in a 1 L reactor equipped with a set of two magnesium electrodes, pH probe (Accumet 13-620-108A by Fisher Scientific) and a magnetic stirrer. The electrodes were shaped as 2 mm thick rectangular plates with an active surface area of 44 cm² and were made of high purity alloy AZ91 HP. Direct current was supplied to electrodes by KEPCO BOP 100-2D. Water deionized in Elix® Water Purification system (Milipore) with electro conductivity EC of 0.08±0.01 μS cm⁻¹ was used for preparation of synthetic solutions. Conductivity measurements during tests were done with Accumet 13-620-165 electrode connected to Accumet XL50 meter by Fisher Scientific.

### Impact of pH and Electric Current on Struvite Purity and Phosphorus Removal Rate

Three-hour batch tests were conducted. The value of pH was continuously adjusted with 0.02N HCl solution dosed by Fisher Scientific Mini Variable-Flow Peristaltic Pump controlled by Eutech alpha pH700 controller. Solution for all tests contained 6.49 g Na₂HPO₄.7H₂O and 2.48 g NH₄Cl, which accounts for 1:1.9 molar ratio of P:N. Conductivity of electrolyte was adjusted to 10 mS cm⁻¹ by dosing NaCl.

Four tests (T1 through T4) were run with electric current of 50 mA and pH set points of 6.5, 7.5, 8.5 and 9.5. Three tests (T5 through T7) were run with pH set point of 7.5 and with the electric current of 100, 150 and 200 mA.

During the tests 6 mL solution samples were grabbed every 30 min. To assess the nutrient removal rate phosphorus and ammonia in the samples were determined by flow injection analysis FIA (QuikChem8500 by Lachat Instruments).

### Impact of Initial Substrate Concentration on Phosphorous Removal Rate

Five three-hour tests (T8-T12) were conducted at different initial ammonia and phosphate concentrations as summarized in the following Table 1. Applied electric current and pH set point (power source and pH control as in previous tests) were the same for all five tests, 100 mA and 7.5 respectively. As in all other tests, 6 mL grab samples were collected every 30 min, filtered and analyzed for ammonia nitrogen and phosphate using FIA.

The following Table 1 summarizes initial ammonia and phosphate concentrations, pH set point and EC in tests T8 through T12.

| | Bulk | Current, | Ammonia, | Phosphate, | N:P, |
|---|---|---|---|---|---|
| Test | pH | mA | mg N/L | mg P/L | mol:mol |
| T8 | 7.5 | 100 | 490 | 548 | 1.98 |
| T9 | 7.5 | 100 | 378 | 418 | 2.00 |
| T10 | 7.5 | 100 | 286 | 313 | 2.02 |
| T11 | 7.5 | 100 | 194 | 214 | 2.00 |
| T12 | 7.5 | 100 | 98 | 105 | 2.05 |

An additional seven-hour test T13 was conducted to access phosphorus removal rate at the elevated N:P concentration ratio. Initial concentrations of ammonia nitrogen and phosphate were 482 mg N/L and 554 mg P/L (N:P molar ratio 1.92), respectively. In order to keep ammonia concentration at a high level throughout the test, 10 mL of 30.6 g NH₄Cl/L (which accounts for 80 mg N) solution was dosed manually to the reaction beaker every two hours.

Phosphorus Removal from Fermented Waste Activated Sludge

Sludge used in the study was waste activated sludge (WAS) originated from South End Water Pollution Control Centre (SEWPCC) in Winnipeg. SEWPCC is high purity oxygen plant (HPO) without nutrient removal. The sludge was collected via return activated sludge (RAS) sampling tap. The sludge was sampled at the same time in the morning during a sludge pumping phase to ensure as much consistency as possible. Sludge was fermented for 48 to 72 h in a 4 L Nalgene batch reactors with low speed impeller mixer. After fermentation the sludge was decanted using IEC Multi centrifuge by Thermo at 6500 RPM. Sludge characteristic is presented in Table S1 (in Supplementary Material).

Three 3-hour tests of struvite precipitation were conducted on the supernatant of fermented sludge. The reactor setup was as in the previous tests. The value of pH was not controlled and the impressed current was set at 50 mA, 100 mA and 200 mA (current density CD of 11.4 A m⁻², 22.7 A m⁻² and 45.4 A m⁻²) in consecutive tests. During the tests 6 mL solution samples were grabbed every 10 to 15 min for FIA analysis of ammonia and phosphates.

### Precipitate Analysis

At the end of tests T1-T7, the precipitate was harvested by filtration of treated solution on glass fiber filters (Whatman 934-AH by GE Healthcare UK Ltd) and dried at room temperature for 48 h. Due to frequent detachment of the precipitate from the surface of the anode harvested samples were mixture of the precipitate from the bulk solution and from the anode. After homogenization of samples, X-ray diffraction (XRD) spectra were collected using a Siemens D5000 powder diffractometer using Cu Kα₁ radiation and operated at 40 kV and 40 mA. The XRD analysis was not conducted on the sample from test T1 due to the insufficient amount of precipitate. Remaining samples were digested in 2% nitric acid for 24 h at 40° C. The magnesium, sodium and phosphorus content of digested samples were assessed by inductively coupled plasma atomic emission spectroscopy analysis (Vista-MPX CCD Simultaneous ICP-OES analyzer by Varian). Digested samples after pH adjustment to were also analysed using FIA to determine the concentrations of ammonium and phosphate. Standard deviation of phosphate results from ICP-OES and FIA analyses did not exceed 2.5%.

### Struvite Purity Calculation

Most of the common struvite mineral impurities do not contain nitrogen, i.e. Mg(OH)₂, MgHPO₄, Mg₃(PO₄)₂; MgKPO₄, CaHPO₄, Ca₅(PO₄)₃OH (Hao et al 2008; Le Corre et al 2005; Zeng and Li 2006). Thus, for purity quantification it was assumed that each mole of ammonium stands for one mole of struvite. The struvite purity SP was calculated as per equation [4].

SP=[NH₄—N]_{prec}.[NH₄—N]ₛₜᵣᵤᵥ⁻¹=[NH₄−N]prec··(57 mg g⁻¹)⁻¹ [4]

where [NH₄—N]_{prec} is the measured concentration of the ammonium nitrogen in the precipitate and [NH₄—N]ₛₜᵣᵤᵥ the theoretical content of the nitrogen in the pure struvite (57 mg N g⁻¹).

Precipitates may also contain magnesium ammonium phosphates (MAP) with different hydration levels than struvite. Dittmarite for instance is MAP monohydrate and its molecular weight is 37% lower than struvite and theoretical content of the nitrogen in pure dittmarite is 90 mg g⁻¹. Since many of the MAP hydrates may exist simultaneously and it is not possible to quantify all of them in the mixture (Sarkar 1991), the assumption was made that in the ambient room temperature and humidity all MAP is hexahydrate (struvite). Even though that this approach may result in purities values higher than 100% authors find this method suitable for engineering use.

The following Table 2 summarizes the characteristics of the sludge used for the phosphorous removal tests.

| | | |
|---|---|---|
| | | Standard |
| Units | Value | deviation |

Raw WAS

| | | | |
|---|---|---|---|
| VS | g L⁻¹ | 6.94 | 0.20 |
| TS | g L⁻¹ | 9.30 | 0.85 |
| TP | mg L⁻¹ | 163 | 18 |
| mg TP/g | mg g⁻¹ | 23.43 | 3.6 |
| VS | | | |
| PO₄—P | mg PO₄—P L⁻¹ | 15.1 | 1.2 |
| tCOD | g L⁻¹ | 10.74 | 0.24 |
| sCOD | mg L⁻¹ | 56.50 | 1.50 |
| pH | | 6.53 | 0.11 |

Fermented WAS supernatant

| | | | |
|---|---|---|---|
| PO₄—P | mg L⁻¹ | 56.1 | 4.2 |
| NH₄—N | mg L⁻¹ | 113.8 | 28 |
| pH | — | 7.65 | 0.40 |
| EC | mS cm⁻¹ | 1.8 | 0.2 |

The following Table 3 summarizes Molar ratios N:P:Mg in precipitates from tests T1 to T7.

| | | | Molar ratio in precipitate |
|---|---|---|---|
| Test | bulk pH | current, mA | N:P:Mg |
| T1 | 6.5 | 50 | 1:1.15:2.36 |
| T2 | 7.5 | 50 | 1:1.16:1.44 |
| T3 | 8.5 | 50 | 1:1.11:1.28 |
| T4 | 9.5 | 50 | 1:1.14:1.57 |
| T2 | 7.5 | 50 | 1:1.16:1.44 |
| T5 | 7.5 | 100 | 1:1.12:1.29 |
| T6 | 7.5 | 150 | 1:1.09:1.30 |
| T7 | 7.5 | 200 | 1:1.05:1.12 |

### Results and Discussion

Impact of pH and Electric Current on Struvite Purity and Phosphorus Removal rate

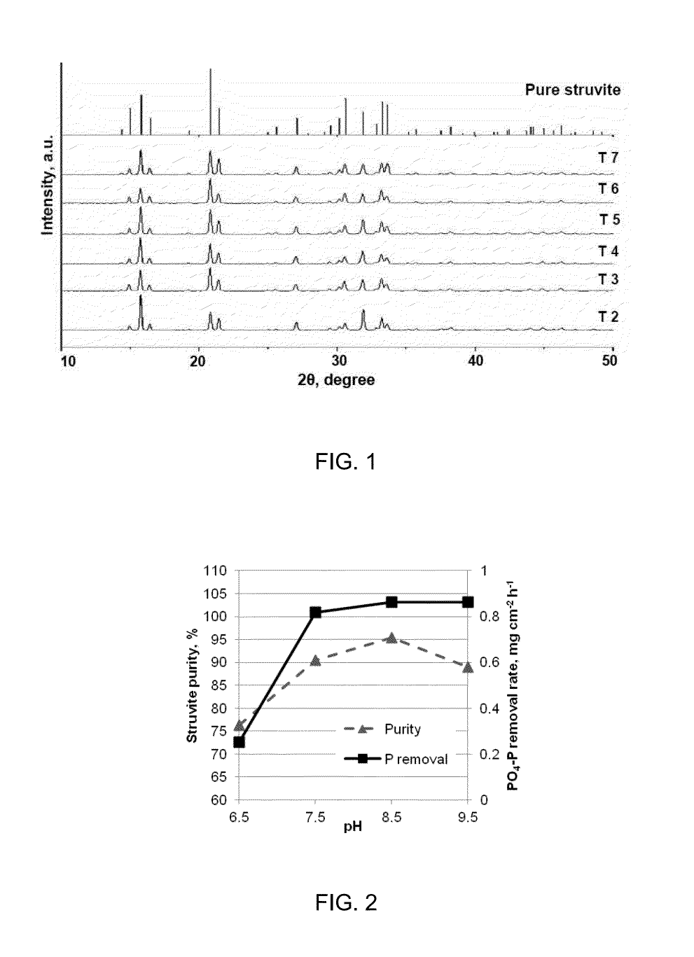

XRD spectra of precipitates from tests T2-T7, presented in FIG. 1, demonstrated high similarity in the position of peaks and relative peaks values to spectrum of struvite standard. That indicated high purity of produced struvite. The molar ratios N:P:Mg in precipitate presented in Tab. S2 (Supplementary Materials) were calculated based on results of ICP and FIA analysis conducted on digested precipitate samples. Molar concentration of N was lower than P and Mg in all samples. This is in agreement with expectations, since most of struvite impurities, e.g. Mg(OH)₂, MgHPO₄, Mg₃(PO₄)_{2;} and when other ions are present e.g. MgKPO₄, CaHPO₄, Ca₅(PO₄)₃OH, do not contain ammonium ions (Hao et al 2008; Le Corre et al 2005; Zeng and Li 2006). Thus, for purity quantification it was assumed that each mole of ammonium stands for one mole of struvite.

Purities calculated for tests T1-T14, where the current was constant at 50 mA and the pH was changed in consecutive steps from 6.5 to 9.5 (FIG. 2), indicate that optimum pH for struvite precipitation is in the vicinity of 8.5. High struvite purity above 90% was achieved in whole range of pH from 7.5 to 9.3. There are few reports of struvite precipitation at pH below 7 (Doyle et al 2002; Zeng and Li 2006), however in this study, even at pH of 6.5 the purity at 76% was still relatively high. The increase of pH from 6.5 to 7.5 resulted in an over three-fold increase of phosphorus removal rate, from 0.25 to 0.82 mg PO₄—P cm⁻² h⁻¹ (FIG. 2). Further increase of pH resulted only in a 5% increase of P removal rate and reached plateau at 0.86 mg PO₄—P cm⁻² h⁻¹ at pH of 8.5. Thus, increasing the solution pH above 8.5 was not beneficial for the quantity or for the quality of produced struvite.

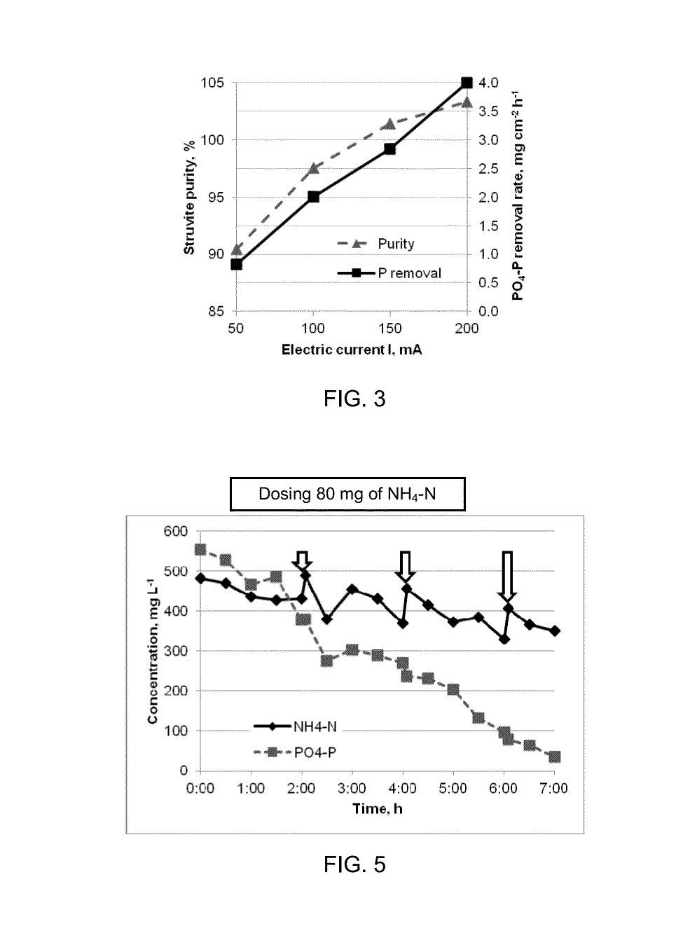

It was shown that struvite purity increased with increased values of applied electric current (FIG. 3). The current increase from 50 mA to 200 mA resulted in a 13% increase of struvite purity at pH of 7.5. According to the Faraday's laws of electrolysis, mass of magnesium released from the anode is proportional to the delivered charge. Theoretical magnesium release can be calculated using the following equation.

mₜ=A·I·t(n·F)⁻, [g] 8 5]

where mₜ is theoretical magnesium release [g], A is atomic weight of magnesium (24.3 g mol⁻¹), I is electric current [A], t is time elapsed [s], n is magnesium valence (2) and F is Faraday constant (96,485 C mol⁻¹).

However observed magnesium release can be even higher due to: (a) the loss of metal by spalling (detachment of metal chunks), (b) self-corrosion, (c) the formation of meta-stable monovalent magnesium ions and (d) charge wastage due to hydrogen evolution (Kim et al 2000; Andrei et al 2003). Hug and Udert (2013) reported observed magnesium release to be up to 220% higher than theoretical. Stratful et al (2001) identified magnesium concentration as the main factor limiting struvite precipitation. Thus, correlation between the purity and the current observed in the present study may be explained by the aforementioned higher magnesium release rate at higher current, which elevated the Mg:P molar concentration ratio in the vicinity of the anode.

The phosphorus removal rate was established to be proportional to the electric current in the studied current range (FIG. 3). Phosphorus removal rate from the synthetic solution of 4.0 mg PO₄—P cm⁻² h⁻¹ was achieved at a current density of 45.5 A m⁻², which is comparable with 3.7 mg PO₄—P cm⁻² h⁻¹ at 55 A m⁻² reported by Hug and Udert (2013). Based on the results it seems that the higher the current the better is the overall system efficiency. However, to establish an optimum operation current two major factors should be considered: (a) local electric power and struvite prices and (b) impact of current density on biomass if coupled with biological treatment. Wei et al (2011) discovered that electric current density of 6.2 A m⁻² does not significantly affect biomass viability for at least 4 hours. They did find though that the current density of 24.7 m⁻² decreased live cell count by 29%.

Cycles of deposition crust build-up and self-detachment on the surface of the anode were observed. Cycle time decreased when impressed current increased. On the surface of the cathode only a thin, white film-like layer was deposited. Therefore, no electrodes scraping was required.

Impact of Initial Substrate Concentration on Phosphorus Removal rate

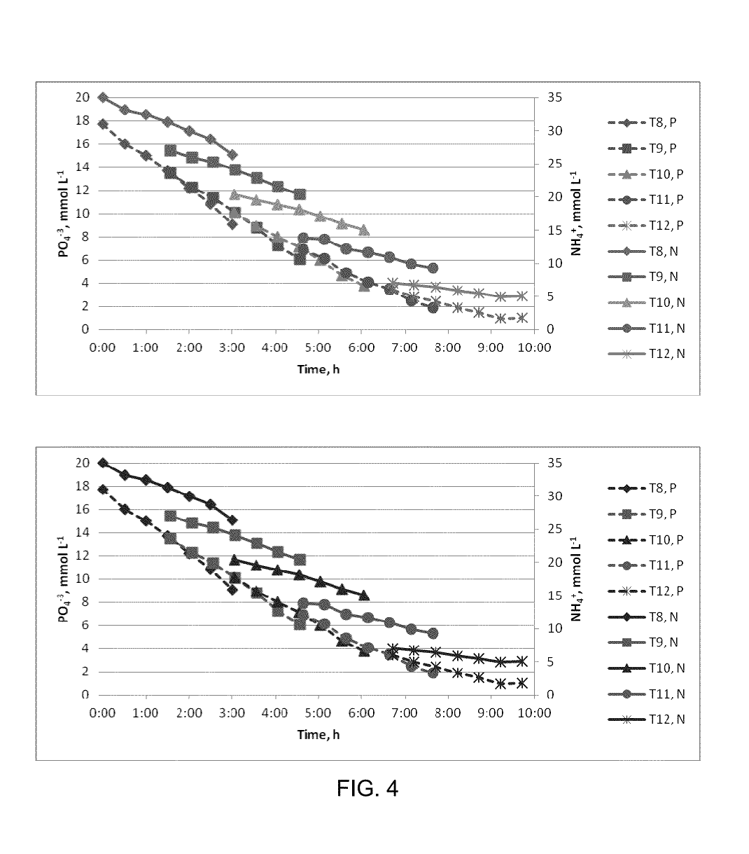

Tests T8 to T12, presented in FIG. 4 indicate that the phosphorus removal rate decreased with initial concentrations of ammonia and phosphate in the solution. Phosphorus removal rate deteriorated from 2.00 mg PO₄—P cm⁻² h⁻¹ in test T8 to 0.57 mg PO₄—P cm⁻² h⁻¹ in test T12 (initial concentrations presented in Tab.1). This is in agreement with the expected decrease of struvite precipitation due to lower supersaturation of solution.

Tests T8-T12 were conducted with initial N:P mass concentration ratio close to 1. In practice, the mass concentration of phosphorus (PO₄—P) is much smaller than mass concentration of ammonium nitrogen, e.g. liquor from sludge dewatering at wastewater treatment plants. Thus, concentration of ammonium nitrogen in test T13 was kept at elevated level throughout the test by dosing ammonium chloride. In T13 (FIG. 5) it was shown that it is possible to obtain high phosphorus removal rates in lower phosphorus concentration range, i.e. an average of 1.38 mg PO₄—P cm⁻² h⁻¹, at concentration of phosphorus between 95 and 35 mg PO₄—P L⁻¹. This meant that the decrease of phosphorus removal rate due to lower concentration of phosphorus may have been offset by higher N:P molar concentration ratio.

Phosphorus Removal from Fermented Waste Activated Sludge

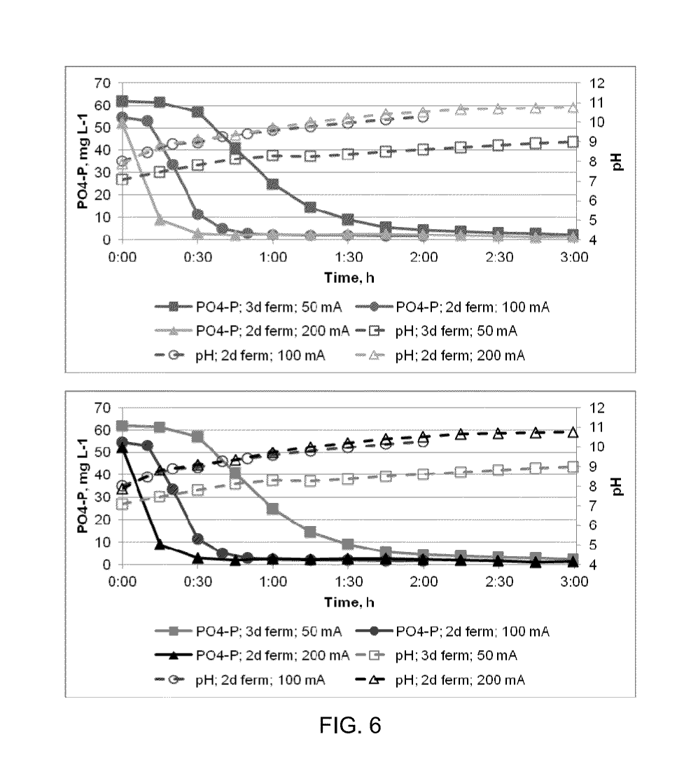

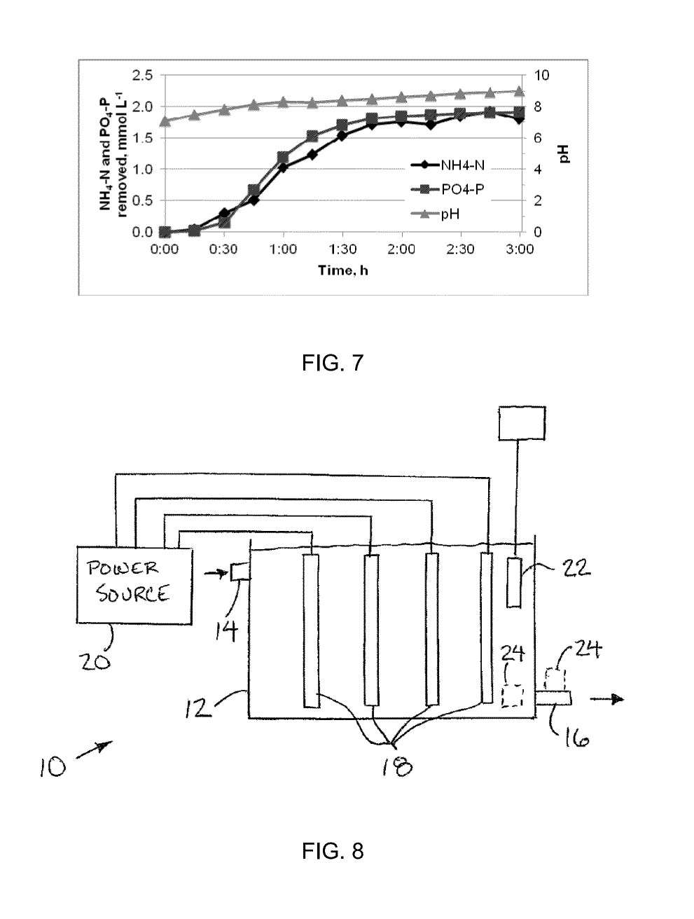

Tests performed on SEWPCC WAS fermented for 2-days and for 3-days showed high phosphorus removal rates, strongly dependent on applied electric current (EC). At 200 mA maximum removal rate was 3.95 mg PO₄—P cm⁻² h⁻¹, and at 50 mA 1.45 mg PO₄—P cm⁻² h⁻¹. The results are comparable to those achieved in tests with synthetic solutions 4.00 mg PO₄—P cm⁻² h⁻¹ in T7 (pH of 7.5 and EC of 200 mA) and 0.82 mg PO₄—P cm⁻² h⁻¹ in T2 (pH of 7.5 and EC of 50 mA). The presented method was capable of reducing phosphorus to very low levels, i.e. 1.3 mg PO₄—P L⁻¹ at applied current of 200 mA or 2.4 mg PO₄—P L⁻¹ at 50 mA. That translated to P removal efficiencies in the range of 95 to 98% at relatively low initial P concentrations of 56 mg PO₄—P L⁻¹. For comparison, fluidized bed struvite precipitation processes have been shown to successfully remove only 70% of P from digester supernatant at concentrations of 40 mg PO₄—P L⁻¹ and achieve up to 90% removal at PO₄ concentrations of 70 mg P L⁻¹ with sufficient Mg addition and pH control (Britton et al 2005). In this research, even at the lowest tested electric current, the almost complete removal of soluble P required not more than 1:45 hours (FIG. 6).

In addition, phosphorus and ammonia were removed in molar ratio close to 1:1. That suggests precipitation of high-purity struvite. Results from tests with the highest initial ammonia concentration (153 mg L⁻¹) are presented in Fig. S1 (Supplementary Material).

### Conclusions

Electrolytic magnesium dissolution was shown to be an effective method of high-purity struvite precipitation and phosphorus removal. The method proved to be very effective in phosphorus removal from fermented waste activated sludge supernatant, achieving removal efficiency of 98% with required hydraulic residence time of under 2 h.

The highest struvite purity was obtained at pH 8.5. Purities higher than 90% were obtained in pH range between 7.5 and 9.3. Although struvite was produced in the whole pH range (6.5-9.5) studied, precipitation at pH 6.5 was inefficient. The increase of applied electric current resulted in an increase of struvite purity and in proportional increase of phosphorus removal.

High phosphorus removal rate of 4.0 mg PO4—P cm-2 h-1 was attained at electric current density of 45 A m-2. The rate depended strongly on initial concentration of ammonia and phosphate in the solution, decreasing when concentrations decreased. The impact of low phosphorus concentration may be offset by increasing the N:P molar concentration ratio. However, the range of current density of 45 A m-2 might inhibit bacteria growth.

Since the proposed method does not require any chemical dosing, does not have any harmful by-products and can produce high purity struvite at relatively low pH of 7.5, it can provide an alternative to chemical and biological phosphorus removal processes in water and wastewater treatment systems. Unlike traditional chemical coagulation or precipitation with aluminium sacrificial anodes, this method allowed actual phosphorus removal and direct recovery as struvite.

### REFERENCES

The following references are referred to in the preceding by author and date and are incorporated herein by reference.

Andrei, M., Di Gabriele, F., Bonora, P. L., Scantlebury, D., 2003. Corrosion behaviour of magnesium sacrificial anodes in tap water. Materials and Corrosion 54 (1), 5-11.

Bellezze, T., Fratesi, R., 2010. Assessing the efficiency of galvanic cathodic protection inside domestic boilers by means of local probes. Corrosion Science 52 (9), 3023-3032.

Britton, A., Koch, F., Mavinic, D., Adnan, A., Oldham, W. and Udala, B., 2005. Pilot-scale struvite recovery from anaerobic digester supernatant at an enhanced biological phosphorus removal wastewater treatment plant. Journal of Environmental Engineering and Science 4,265-277.

Le Corre, K., Valsami-Jones, E., Hobbs, P., Parsons, S., 2005. Impact of calcium on struvite crystal size, shape and purity. Journal of Crystal Growth 283 (3-4), 514-522.

Doyle, J., Oldring, K., Churchley, J., Parsons, S., 2002. Struvite formation and the fouling propensity of different materials. Water Research 36 (16), 3971-8.

Hao, X.-D., Wang, C.-C., Lan, L., Van Loosdrecht, M. C. M., 2008. Struvite formation, analytical methods and effects of pH and Ca2+. Water Science and Technology 58 (8), 1687-92.

Hug, A., Udert, K. M., 2013. Struvite precipitation from urine with electrochemical magnesium dosage. Water Research 47(1), 289-299.

Kim, J., Joo, J., Koo, S., 2000. Development of high-driving potential and high-efficiency Mg-based sacrificial anodes for cathodic protection. Journal of Materials Science Letters 19,477-479.

Ben Moussa, S., Maurin, G., Gabrielli, C., Ben Amor, M., 2006. Electrochemical Precipitation of Struvite. Electrochemical and Solid-State Letters 9 (6), 97-101.

Parthiban, G. T., Parthiban, T., Ravi, R., Saraswathy, V., Palaniswamy, N., Sivan, V., 2008. Cathodic protection of steel in concrete using magnesium alloy anode. Corrosion Science 50 (12), 3329-3335.

Sarkar, A. K., 1991. Hydration/dehydration characteristics of struvite and dittmarite pertaining to magnesium ammonium phosphate cement systems. Journal of Materials Science 26,2514-2518.

Schuiling, R. D., Andrade, A., 1999. Recovery of Struvite from Calf Manure. Environmental Technology 20,765-768.

Sharifi, B., Mojtahedi, M., Goodarzi, M., Vandati Khaki, J., 2009. Effect of alkaline electrolysis conditions on current efficiency and morphology of zinc powder. Hydrometallurgy 99,72-76.

Stratful, I., Scrimshaw, M. D., Lester, J. N., 2001. Conditions influencing the precipitation of magnesium ammonium phosphate. Water Research 35 (17), 4191-9.

Suzuki, K., Tanaka, Y., Kuroda, K., Hanajima, D., Fukumoto, Y., 2005. Recovery of phosphorous from swine wastewater through crystallization. Bioresource Technology\96 (14), 1544-50.

Suzuki, K., Tanaka, Y., Kuroda, K., Hanajima, D., Fukumoto, Y., Yasuda, T., Waki, M., 2007. Removal and recovery of phosphorous from swine wastewater by demonstration crystallization reactor and struvite accumulation device. Bioresource Technology 98 (8), 1573-8.

Wang, C.-C., Hao, X.-D., Guo, G.-S., Van Loosdrecht, M. C. M., 2010. Formation of pure struvite at neutral pH by electrochemical deposition. Chemical Engineering Journal 159 (1-3), 280-283.

Wei, V., Elektorowicz, M., Oleszkiewicz, J. A, 2011. Influence of electric current on bacterial viability in wastewater treatment. Water Research 45 (16), 5058-62.

Zeng, L., Li, X., 2006. Nutrient removal from anaerobically digested cattle manure by struvite precipitation. Journal of Environmental Engineering and Science 5,285-294.

Hug and Uder (2013) presented struvite precipitation from source-separated urine dosing magnesium by electrolytical dissolution. Phosphorus removal rate of 3.7 mg P cm⁻²h⁻¹ at an impressed current density of 55A m⁻² was achieved in a sequencing batch reactor process with a 2 hours cycle. Struvite production cost with electrochemical magnesium dosing at 4.45 [symbol] kg⁻¹ was shown to be competitive with dosing of MgCl₂ and MgSO₄. The results were published after the present study was completed and both research teams were unaware of each other's work.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of precipitating struvite in wastewater, the method comprising:
providing a plurality of electrodes in contact with the wastewater in which at least one electrode comprises a sacrificial anode comprising magnesium; and
applying a current across the electrodes so as to precipitate the struvite by electro-coagulation.

2. The method according to claim 1 wherein the sacrificial anode consists substantially entirely of magnesium.

3. The method according to claim 1 wherein the sacrificial anode is the only magnesium added to the wastewater.

4. The method according to claim 1 including maintaining pH of the wastewater in a range of 7.5 to 9.3

5. The method according to claim 1 wherein the wastewater comprises treated wastewater.

6. The method according to claim 1 wherein the wastewater comprises raw wastewater.

7. The method according to claim 1 wherein the wastewater comprises livestock manure.

8. The method according to claim 1 wherein the wastewater comprises digested municipal sludge concentrates.

9. The method according to claim 1 including biologically treating the wastewater and maintaining a current density of the current applied to the sacrificial anode below a prescribed threshold which is detrimental to the biological treatment.

10. The method according to claim 1 including locating the wastewater in a treatment chamber and increasing a magnitude of the current being applied in response to a measured concentration of phosphorous in an effluent from the treatment chamber exceeding a prescribed phosphorous limit.

11. The method according to claims 1 including recovering the precipitated struvite from the sacrificial anode.
